(19) United States
(12) Patent Application Publication
(10) Pub. No.: US 2019/0275978 A1
(43) Pub. Date: Sep. 12, 2019

(54) ROOF RAIL AIRBAG (RRAB) TRIM RESPONSE SYSTEM, METHOD AND APPARATUS TO IMPROVE ENERGY ABSORPTION EFFICIENCY

(71) Applicant: GM GLOBAL TECHNOLOGY OPERATIONS LLC, Detroit, MI (US)

(72) Inventors: Senthil Karuppaswamy, Rochester Hills, MI (US); Daniel J. Cornelius, Pleasant Ridge, MI (US); Mauricio Eduardo Frias Alvarez, Northville, MI (US)

(73) Assignee: GM GLOBAL TECHNOLOGY OPERATIONS LLC, Detroit, MI (US)

(21) Appl. No.: 15/918,313

(22) Filed: Mar. 12, 2018

(51) Int. Cl. B60R 21/2334; B60R 21/04; B60R 21/213; B60R 21/217; B60R 21/232

(52) U.S. Cl. CPC B60R 21/2334; B60R 21/0428; B60R 21/232; B60R 21/2176; B60R 21/213

(57) ABSTRACT

Systems, methods and apparatuses are provided of a trim component assembly affixed to a pillar assembly, and a trim bumper element inserted between the trim component assembly and the pillar assembly to support the trim component assembly during an impact, the trim bumper element configured to deflect from a base shape when a load is applied to the trim bumper element to prevent for a period a detaching of the trim component assembly from the pillar assembly by enabling a load of a constant force to be received by the trim component assembly by a transfer of force related to the load in part to the pillar assembly while the base shape of the trim bumper element deforms in response to the load applied.

### TECHNICAL FIELD

The present disclosure generally relates to systems, methods and apparatuses for transferring impact loads, and more particularly relates to a dual purpose RRAB shape maintainer and crushable load transfer insert that provides trim component retention and transfers impact loads from the trim component to a support metal frame without impeding airbag deployment.

### INTRODUCTION

The A-pillar trim requires enhanced support for proper retention of trim components when functioning to a required crush efficiency to counteract forces of interior head impact events. Currently, a larger A-pillar section is required to address and meet this required impact criteria, but the larger A-pillar section can in certain circumstances lead to less than optimal pillar packaging, styling, or use of interior vehicle space.

Accordingly, it is desirable to provide systems and apparatuses that provide enhanced crush efficiency to A-pillar sections which provides shape maintenance to a trim component assembly and crushable load transfer for a transfer of impact forces from the trim component surface to an underlying metal frame of the A-pillar without impeding airbag deployment. Furthermore, other desirable features and characteristics of the present invention will become apparent from the subsequent detailed description and the appended claims, taken in conjunction with the accompanying drawings and the foregoing technical field and introduction.

### SUMMARY

Systems, methods and apparatuses are provided with trim bumper elements that have responsive force characteristics for a variety of applications.

In various embodiments, a system is provide that includes: a trim component assembly affixed to a pillar assembly, and a trim bumper element inserted between the trim component assembly and the pillar assembly to support the trim component assembly during an impact, the trim bumper element configured to deflect from a base shape when a load is applied to the trim bumper element to prevent for a period a detaching of the trim component assembly from the pillar assembly by enabling a load of a constant force to be received by the trim component assembly by a transfer of force related to the load in part to the pillar assembly while the base shape of the trim bumper element deforms in response to the load applied.

The system further includes: one or more extensions extending from the trim bumper element configured to hold an airbag prior to deployment during the impact wherein the extension bend in response to the load applied to absorb the force of the load in part. The one or more extensions bend in manner not to impede the deployment of the airbag. The trim bumper element is configured to vary the force as the trim bumper element deflects the load. The trim bumper element has a shape that is irregular and that is determined by a cavity within which the trim bumper element is disposed. The trim bumper element has a side view with a width, wherein the width varies along the length of the trim bumper element. The extensions include ribs and grooves which are configured to vary the force of support of the airbag as the trim bumper element deflects the applied load. The trim bumper element has a figure eight shape on a distal end.

In another embodiment, a method of energy absorption is provided. The method includes: forming a trim bumper element in a base shape which deflects when a load is applied to the trim bumper element, the trim bumper element formed of a polymer material; and positioning an impact element so that the trim bumper element is responsive to a force applied by the impact element to transfer the force to a pillar assembly of the vehicle.

The method includes: forming the trim bumper element with an extension that is configured to vary the force as the trim bumper element deflects the load. The method includes: forming the trim bumper element with a shape that is irregular and that is determined by a space within which the elastic element is disposed. The method includes: shaping the trim bumper element on a distal end with an extension to hold an airbag. The method includes: shaping the trim bumper element with sections of different widths for affixing to pillar assembly. The method includes: casting grooves in the extension wherein the grooves are configured to vary the force as the trim bumper element deflects the load. The method includes: deforming the trim bumper element to absorb the force of the impact element. The deforming includes: bending the trim bumper element in a manner not to interfere with a deployment of an airbag.

In yet another embodiment, an apparatus for absorbing load forces is provided. The apparatus includes: a trim component assembly affixed to a pillar assembly, and a trim bumper element inserted between the trim component assembly and the pillar assembly to support the trim component assembly during an impact, the trim bumper element configured to deflect from a base shape when a load is applied to the trim bumper element to prevent for a period a detaching of the trim component assembly from the pillar assembly by enabling a load of a constant force to be received by the trim component assembly by a transfer of force related to the load in part to the pillar assembly while the base shape of the trim bumper element deforms in response to the load applied.

The apparatus includes: one or more extensions extending from the trim bumper element configured to hold an airbag prior to deployment during the impact wherein the extension bend in response to the load applied to absorb the force of the load in part. The one or more extensions bend in manner not to impede the deployment of the airbag. The trim bumper element is configured to vary the force as the trim bumper element deflects the load.

### BRIEF DESCRIPTION OF THE DRAWINGS

The exemplary embodiments will hereinafter be described in conjunction with the following drawing figures, wherein like numerals denote like elements, and wherein:

FIG. 1 illustrates a schematic of a trim bumper element inserted in the trim component assembly in accordance with an embodiment;

FIGS. 2A-B illustrate an offset of the trim assembly component and changed design configuration enabled by support of the trim bumper element inserted in the trim component assembly in accordance with an embodiment;

FIG. 3 is a graph of acceleration versus time of forces and rate of absorption of forces of an impact to a pillar assembly in accordance with an embodiment;

FIG. 4 is an illustration of a load transfer from a surface of trim component assembly to a base state of a trim bumper element in accordance with an embodiment;

FIGS. 5A-C illustrate deformation of base state to varying degrees of deformation of the trim bumper component structure in response to increasing forces of load transfers due to an impact in accordance with an embodiment;

FIGS. 6A-D illustrate various different design configurations of the trim bumper element for use in pillar assemblies of a vehicle in accordance with an embodiment;

FIGS. 7A-D illustrate various different design configurations of distal perpendicular protrusions of the trim bumper element for use in pillar assemblies of a vehicle in accordance with an embodiment; and

FIG. 8 illustrates placement of the trim bumper element in a pillar assembly of a vehicle in accordance with an embodiment.

### DETAILED DESCRIPTION

The following detailed description is merely exemplary in nature and is not intended to limit the application or its uses. Furthermore, there is no intention to be bound by any expressed or implied theory presented in the preceding technical field, introduction, brief summary or the following detailed description.

In one or more example implementations of the disclosed trim bumper element in the trim component assembly apparatus and system and method, a trim bumper element is provided of various designs configurations.

The current description of the trim bumper relates to trim component assembly design that may be described in the context of an impact safety system and in particular, energy absorption systems, for purposes of demonstrating responses to collision forces of impacts to the surface of the trim component assembly. During a collusion, it is necessary to dissipate impact forces received on the surface of the trim component assembly while retaining a transfer path and retention to a metal frame of pillar assembly, (ex. A-pillar assembly) particularly for interior head impacts. Use of the trim bumper element provides a dual purpose of RRAB shape maintenance and for a crushable load transfer of impact forces from the surface of the trim assembly component to sheet metal of the pillar assembly with a metal catcher footprint while not impending deployment of the RRAB.

In addition, by use of the trim element bumper, more freedom in choices for A-pillar surface styling of the trim component assembly is provided by removing or at least limiting necessary energy absorption features by the structure of the trim component assembly of having a teardrop shaped A-pillar trim component assembly surface design. That is, the teardrop shaped A-pillar trim component assembly surface design deemed necessary for the higher crush depth is no longer required with the insertion of the trim bumper element which absorbs transferred load forces from the surface of the trim assembly component and transfers load to the metal of the A-pillar. Also, the trim bumper may be installed along with the RRAB attachment so no additional body attachment is required. That is, the trim bumper component is configured in manner with apertures that ride on the fasteners of the trim component assembly and the A-Pillar assembly. Hence, the trim bumper component is tailored inclusion in legacy vehicle trim component assemblies without any modification or any significant modification in the fastening system that supports the trim component assembly to the A-pillar of the vehicle.

The present disclosure is not limited to trim component assemblies or A-pillar assemblies in general, but rather, also encompasses any trim assembly where an application of a force transfer is desired. Accordingly, the teachings of the present disclosure are applicable to a trim assembly apparatus and system in a variety of applications, such as vehicle machinery and equipment, and others.

In an exemplary embodiment of the present disclosure as further described below, a trim bumper element is configured to deflect from a base shape when a load is applied and in instances, to resume the base shape when the load is removed. If, however, the load applied exceeds a threshold, the trim bumper element may be deformed as a result of the increased load and the trim component assembly may also be deformed and/or detached as a result of the collision to absorb load forces received from a collision. The trim bumper element in alternative embodiments may be formed of a metallic, plastic, rubber or similar materials that has responsive load force deformable characteristics.

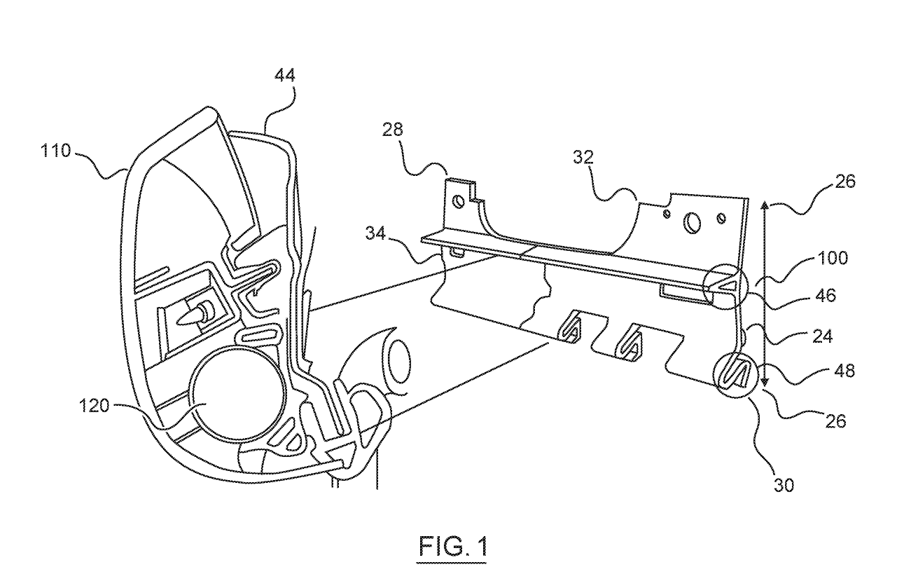

The trim bumper element is responsive to a force applied to trim component assembly to effect a desired action such as detachment of the trim component assembly and/or deployment of an RRAB. Accordingly, with reference to FIG. 1 a trim bumper element 100 is shown in its base shape. The trim bumper element 100 is formed as an elastic manual able structure (i.e. rubber mold) that is deformable when a force is applied to the trim component assembly 110 above a certain threshold.

The trim bumper element 20 has an external diameter in a range of 25-50 mm (though subject to design change) measured across its center 24 to its peripheral edge on each side 28, 30. The trim bumper element 100 has openings 32 and 34 for aligning and attaching to the A-Pillar metal sheath 44.

Various embodiments of the trim bumper element 100 can include different cross-sectional areas, different lengths for supporting the trim component assembly, different sectional areas for affixing between the trim assembly component and the pillar assembly and for aligning to the metal of the pillar assembly for transferring load forces, and different configurations of cushioning and grip protrusions integrated in the trim bumper element 100 to hold or support the RRAB. Conversely, different dimensions for external diameters, recesses, grooves, ribs, distal ends, lengths and other features or shapes of the configured trim bumper element 100 will result.

When in the base shape of the trim bumper element 100 as shown in FIG. 1, inserted in the trim component assembly 110 behind the RRAB 120 in a manner that perpendicular cone extensions or perpendicular protrusions 48 and 46 of the trim bumper element 100 act as clasps or grips from a slight curved structure to hold the RRAB 120 by lateral force in a cavity formed by the cone or perpendicular protrusions 48 and 46. The RRAB 120 is placed in a removable manner gripped by the cone or perpendicular protrusions 48 and 26. The trim bumper element 100 has a thickness of approximately 6 mm which may be consistent in parts, or may vary depending on the configuration. In various embodiments, different configurations of the cone extensions or perpendicular protrusions may be used to provide lateral support for the RRAB as well as cushioning to absorb load forces transferred to the trim bumper element 100. That is, the trim bumper element 100 may include different distal end structural configurations to support the RRAB 120 with integrated spaces and structural members to provide both grip by lateral force to the RRAB 120 as well as to provide rear absorption of load forces by deformation of the distal end structure when load forces are received. Additionally, the trim bumper element 100 may be inserted in a compressed like stressed insert providing counter lateral support from the metal sheath 44 by resting on the metal sheath 44 or placed in a not compressed unstressed insert in the cavity between the RRAB and the metal sheath 44.

In the embodiment of FIG. 1, the trim bumper element 100 may be formed using a variety of materials including polyurethane, thermoplastic, polyvinyl chloride, polyisoprene, neoprene, silicone, glass fibers, etc. The material may be formed in the desired shape through the use of a mold such as in casting or injection molding.

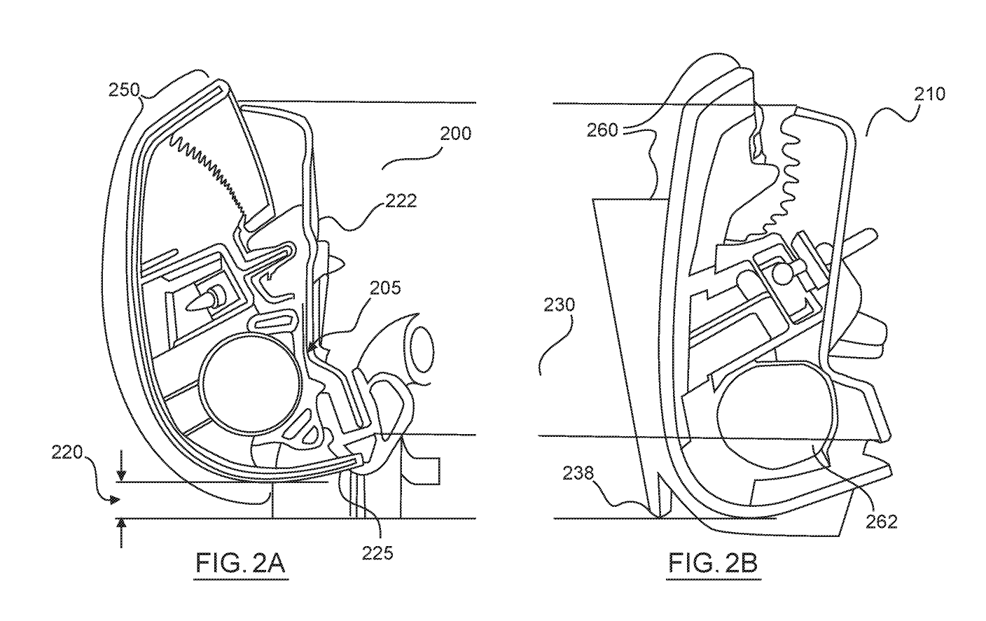

In FIGS. 2A and 2B, the trim bumper element 205 of the trim component assembly 200 raises the trim edge 220 of the trim component assembly 200. The trim edge 225 is higher than the trim component assembly 210 without the trim bumper element 205 because the trim component assembly 200 is supported by the trim bumper element 205 which in turn raises the entire trim component assembly 200. This enables more freedom in the A-surface 250 styling by removing energy absorption features from the trim component 200 itself and there is no longer a need to rely on a tear drop design of the A-surface 260 of the trim component assembly 210 to give the needed crushable space to absorb the transfer of load forces from a collision with the A-surface 260. Hence, the A-surface 250 of the trim component assembly 210 does not need to extended as far or wrap around into the A-pillar assembly as the A-surface 260 as the additional support of the A-surface to the A-pillar is no longer needed to preserve space for deployment of the RRAB 262 and for extended crushable support for the load transfer. That is, the trim bumper element 205 insert provides the mechanics for the load transfer by absorbing the load forces, responding by deforming in shape to the load forces and transferring the load forces directly, by resting against the back metal 222 of the A-pillar, from the trim assembly component 200 of A-surface 250 to the back metal 222 of the A-pillar without needing the extended crush protection of the extended surface of the A-surface 260.

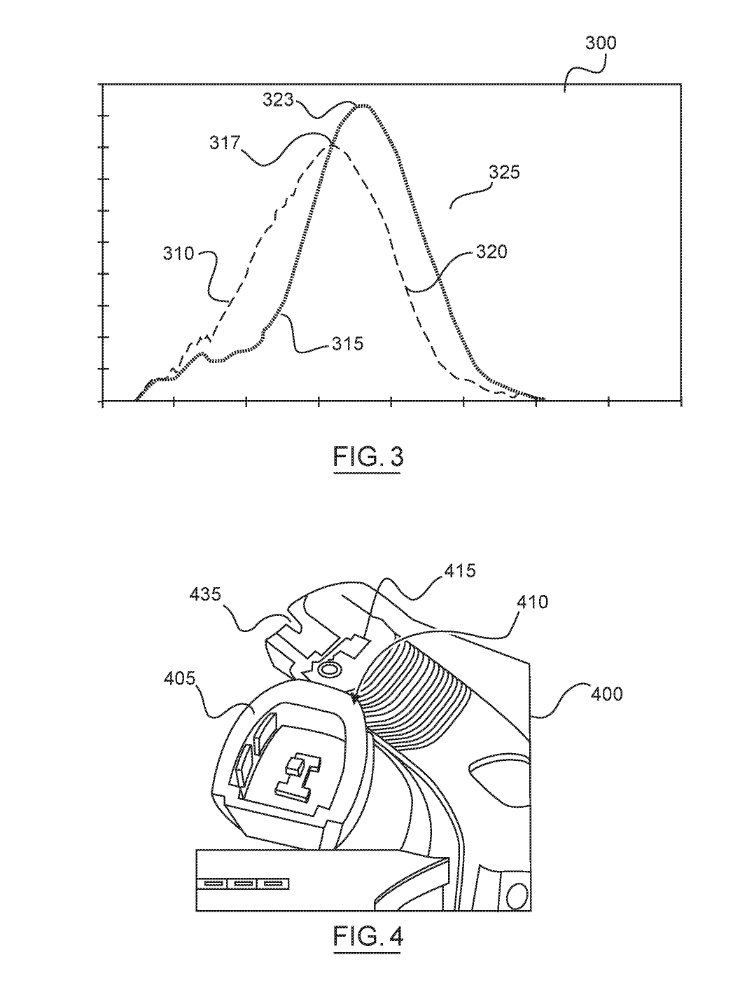

Referring to FIG. 3, FIG. 3 illustrates a time versus acceleration plot for the load transfer of an impact with and without the trim bumper element. In a control mode, shown in the graph of FIG. 3, a same load is applied to the trim component assembly. Initially, a more linear response 310 of the displacement in the curve of the graph with respect to the acceleration of the forces of the impact to the trim component assembly. That is, the absorbing energy can be seen to be in a constant rate reducing the overall peak acceleration 317 measured by the impact to the trim component assembly. As illustrated in FIG. 3 without the trim bumper element, the initial response 315 to the acceleration of the impact is not linear resulting in higher displacements of incremental forces applied and the peak acceleration at 323 is significantly higher that the peak acceleration 317 achieved with the trim bumper element and the transfer and absorption of the load forces by the bumper element to the underlying metal layer of the pillar assembly. In other words, the trim bumper element by compression and deformation of its structure reduces the overall displacement and reduces the peak acceleration which in turn results in less force experienced from the impact. The increase in the peak acceleration 323 results in a lower time 325 for the decrease in acceleration to be achieved compared to with the trim bumper element 320 which means the displacement to return to the prior initial point of zero acceleration occurs in shortened period resulting in higher reverse acceleration forces expended to counter the higher peak acceleration. Hence, the trim bumper element shifts and lowers the acceleration curve so the effects of the acceleration are reduced both in the forward and reverse directions during the collusion. The head injury criteria index HIC(d) is lowered by an amount of about 150+ value compared to the results without the trim bumper element as a result of the reduced peak accelerations achieved.

FIG. 4 illustrates the load transferring and deformation of the trim assembly component. The load 410 of part 405 collides and exerts lateral forces to the trim component assembly 400. The deformation by the load 410 of the trim component assembly 400 surface is show initially at 410 with a slight indentation of the surface of the trim component assembly 400 on the surface portion. The trim bumper element 415 holds or grips the RRAB 435 with perpendicular protrusions during the initial impact of the load experience by the part 405. Also, the trim bumper element 415 provides support for the trim component assembly 400 initially as the impact occurs so the trim component assembly remains affixed to the pillar assembly during the initial impact. As the trim component assembly 400 deforms, the load transfer pushes lateral forces into the perpendicular protrusions of the trim bumper element 415 which in turn absorbs these lateral forces and deforms in part while transferring load forces to the metal underlying layer of the pillar assembly. Because of the trim bumper element 415, the trim component assembly 400 remains intact and in position longer due to the support by the insertion of the trim bumper element 415 at the initial impact of the collision then without the insertion of the trim bumper element 415 while the trim component assembly 400 begins to initially deform at the surface structure.

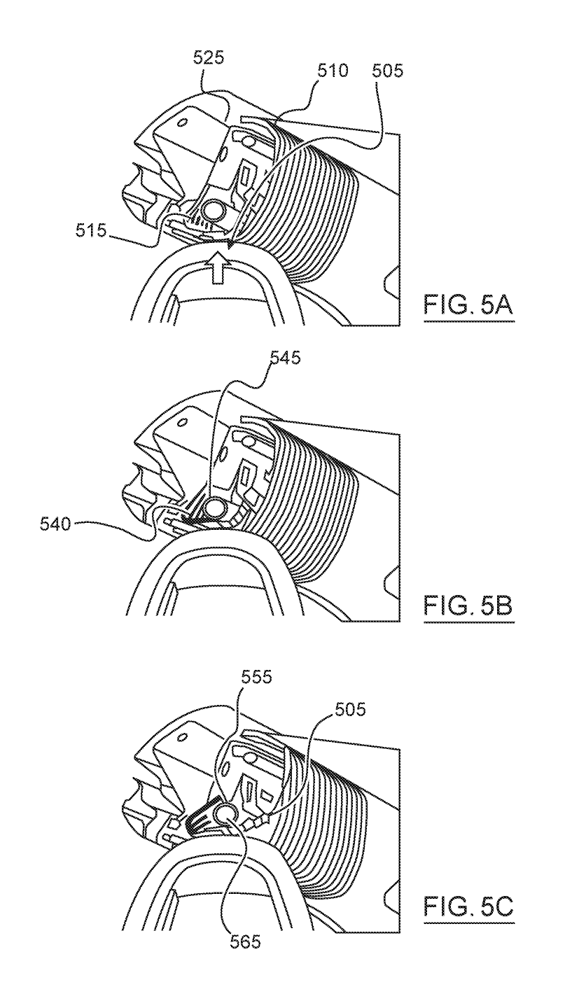

FIGS. 5A, 5B and 5C illustrate a series of moment by moment impact affects and compressions steps of the trim assembly component with the trim bumper element in accordance with an embodiment. In FIG. 5A, initially an impact of the part 505 comes in contact with the trim component assembly 510 residing on the metal layer of the A-pillar assembly 525. The trim bumper element 515 is initially not deformed and holds the RRAB and the trim assembly component 510 together. In other words, the trim bumper element 515 provides support for the trim component assembly surface which comes in contact with the force of impact of the part 505 as the part 505 collides with the surface of the trim component assembly 510.

In the next moment, after the initial contact of the part 505 with the surface of the trim component assembly 510, the surface of the trim component assembly 510 begins to deform in response to the force exerted on the surface by the part 505. The outer perpendicular protrusions at the distal end of the trim bumper element 545 begin to cave in in response to the lateral force exerted by the part 505 in a perpendicular angle to the A-pillar assembly 525. The trim bumper element 545 still holds the trim component assembly 510 to the A-pillar assembly 525 and transfers part of the load experience to the metal underlying layer of A-pillar assembly 525 to absorb the force of the collision. The deformation of the trim bumper element 545 and the collapsing of the perpendicular protrusions 540 on the distal end of the trim bumper element 545 occurs in a manner to decelerate and linearize the acceleration forces of the impact of the part 505. That is, the acceleration follows a linear trajectory where the acceleration increase does not spike but follows a gradual increase limiting any excessive jarring forces impacting the part 505.

FIG. 5C illustrates further deformation of the trim bumper element 555 where the part 505 from the impact continues to apply lateral force to the trim component assembly 510 resulting in further compression of the trim component assembly 510. The forces applied to the surface of the trim component assembly 510 are in turn absorbed in part by the deformation in the structure of the trim bumper element 555. Use of different materials as well as design changes to the thickness of the trim bumper element 555 can regulate the amount of lateral force absorbed by the trim bumper element 555 and manipulate the stiffness or rigidity of the base state of the trim bumper element 555. Further, the trim bumper element 555 may be inserted in a compressed state at the onset to respond to lateral forces and provide a higher degree of cushion to the trim component assembly 510. The perpendicular protrusions from the trim bumper element 555 respond to lateral forces of the trim component assembly 510 by collapsing or deforming further from the base or perpendicular position. The RRAB 565 is not impeded by the deformation of the trim bumper element 555, as the perpendicular protrusions collapse in manner to recede away from area of deployment of the RRAB 565 thereby maintaining sufficient area for the RRAB 565 to deploy in the direction and manner without the trim bumper element 555 interfering due to its deformation in structure.

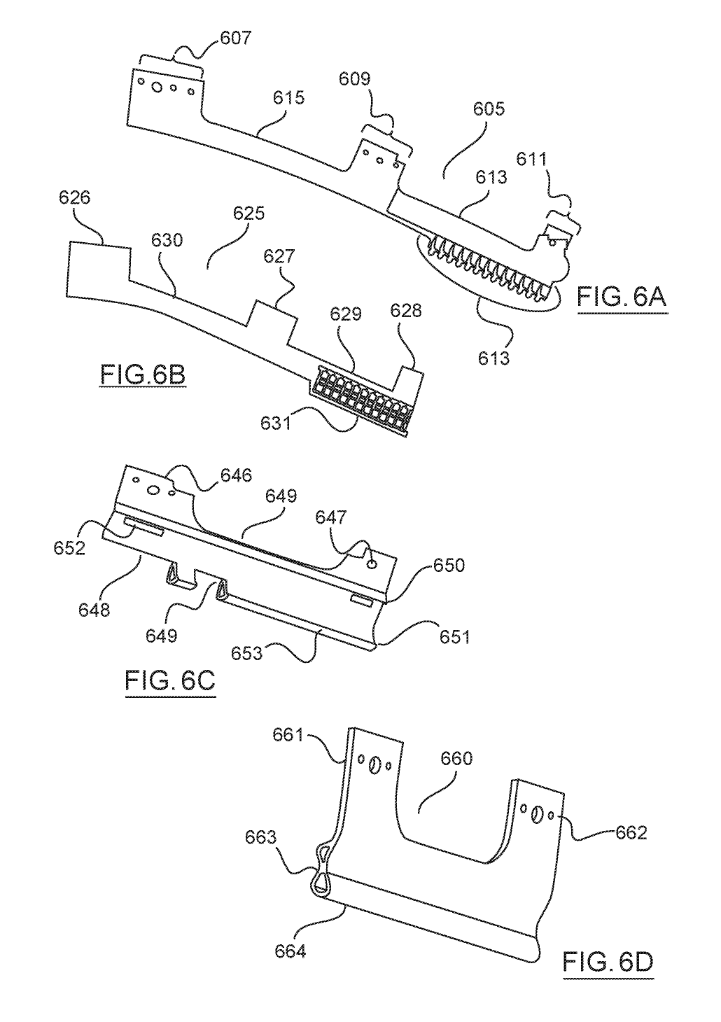

FIGS. 6A-D illustrates various alternative design structures for the trim bumper element for use in different pillar assembly types including other A-pillar assemblies. FIG. 6A illustrates an elongated design for a trim bumper element 605. The trim bumper element 605 includes wing planar sections 607, 609 and 611 for aligning and attaching to the pillar of the vehicle. Recessed sections 615 and 613 allow for aligning to the pillar assembly to support the trim assembly component without obstructing views as well as providing tensile strength to the pillar assembly.

Also, in the lower distal end of recessed sections 613, a set of perpendicular protrusions with serrated interiors for holding an RRAB in place is provided. FIG. 6B is another embodiment of a trim bumper element 625 with winged planar sections 626, 627 and 628 for aligning with the pillar assembly and (not shown) for attaching if needed to the pillar by placed holes or apertures. Recessed sections 630 and 629 are also included to allow for supporting the trim assembly component as well as providing tensile strength to the pillar component. At a distal end of the trim bumper element 625, longer grooved serrated protrusions 631 are provided for securing and holding an RRAB prior to deployment.

FIG. 6C, a trim bumper element 645 is provided with distal planar sections 646 and 647 with each of the distal planar section having apertures for screws for affixing and aligning and attaching with the trim component assembly and pillar assembly. Additionally, recessed sections 648 and 649 and perpendicular protrusions 651 and 650 for holding the RRAB. Slide apertures 652 and 653 are included for attaching without needing exact alignments and for adjustments of the trim bumper element 645 with the trim component assembly and the pillar assembly. That is, the trim bumper element 645 may be adjusted in the vertical direction when affixed either to the trim component assembly or the pillar assembly for further adjustments.

FIG. 6D illustrates a trim bumper assembly 660 with two extended distal sections 661 and 662 and rear perpendicular protrusion 663 for cushioning against the metal elements of the pillar assembly. That is the RRAB is affixed in the front planar surface of a slight lip 664 while the rear perpendicular protrusion 663 absorbs impact forces from the front surface of the trim bumper element 660 by deforming in response to the collusion. The RRAB deployment area is unchanged and is held by a slight lip 664 on the front surface of created by the rear perpendicular protrusion 663. Hence, most of the deformation of the trim bumper element 660 in this embodiment occurs in the rear planar surface area and not in the front planar surface that experiences the collusion forces. The collusion forces are transferred to the rear perpendicular protrusion 663 that deforms with a linear acceleration in response to the impact forces.

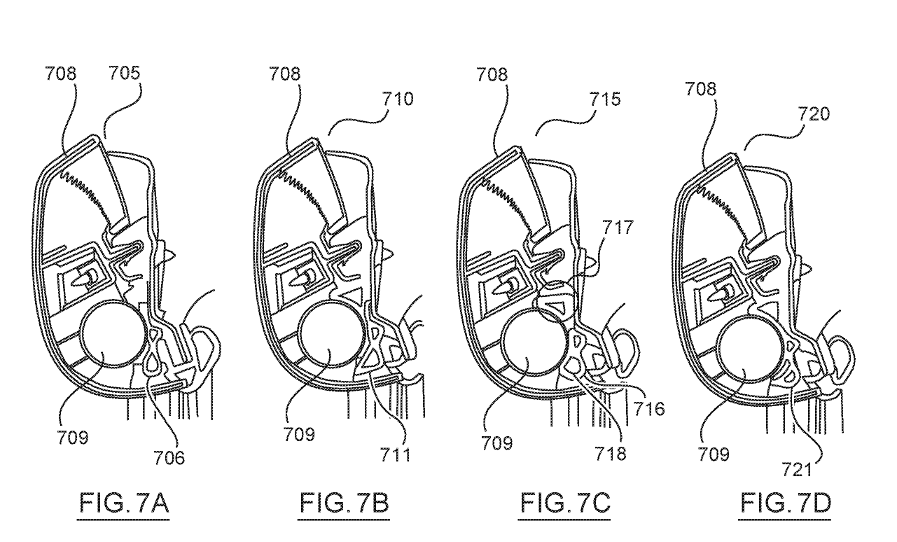

FIGS. 7A-7D illustrate various exemplary embodiments of the trim bumper element structure configurations. That is, FIGS. 7A-7D show various alternative design embodiments of the vertical perpendicular structure of protrusions of the trim bumper element for use in the cavity of the pillar assembly with the trim component assembly. In various embodiments, different levels of stiffness for the trim bumper element may be provided by each different design, cross-sectional areas, thickness etc. and may result in different levels of response and absorption to collusion forces and abilities to hold or support the RRAB and trim component assembly.

In FIG. 7A, the trim bumper element 706 has a distal end shaped in a figure eight configuration providing cushioning to the RRAB 709 and supporting the trim component assembly 708 of the pillar assembly 705. In this instance, the trim bumper element 706 provides limited grasp of the RRAB 709 as the trim bumper element 706 is configured in manner that is not significantly curved to hold the RRAB 709 but is enabled to provide rear cushioning on impact of the trim component assembly 708 surface with the metal frame of the pillar assembly 705.

FIG. 7B, the trim bumper element 711 of the pillar assembly 710 is configured with the distal end with a slight curve to support the RRAB 709. This configuration of the trim bumper element 711 has slightly more of a perpendicular protrusion that is curved in the base state to enable more support of the RRAB 709 while providing an impact absorption to impact forces from the surface of the trim component assembly 708 to the metal surface of the pillar assembly 710.

FIG. 7C illustrates a trim bumper element 716 with more curvature on both distal ends of the trim bumper element 716 that provides supports as well as holds the RRAB 709 in place while still providing cushioning support for forces at the surface of the trim component assembly 708. The distal end 717 is a linear protrusion without rear cushioning like the distal end 718. In other words, only one side of the trim bumper element 716 in this configuration provides more cushioning to impact forces at the surface of the trim component assembly 708 to the metal of the pillar assembly 715; the other distal end 717 by a configuration without a rear cushioning structure provides limited absorption of impact forces.

FIG. 7D illustrates a trim bumper assembly 721 in which both distal ends are configured in extended perpendicular curved protrusions to hold the RRAB 709 and also by the structure of the perpendicular protrusions provide rear cushioning to impact forces at the trim component assembly 708 surface for transferring loads to the metal of the pillar assembly 720. This particular configuration, provides more structural support for the RRAB and the trim component assembly 708 and absorbs more impact forces and the rear structure of the perpendicular protrusions can deform in response to impact forces on both distal ends and transfer the force to the metal of the pillar assembly 720. In addition, the trim bumper element 721 is configured in a manner to have more structure and more internal support members lending to stiffer perpendicular curved protrusions that hold the RRAB 709 and absorb more impact forces.

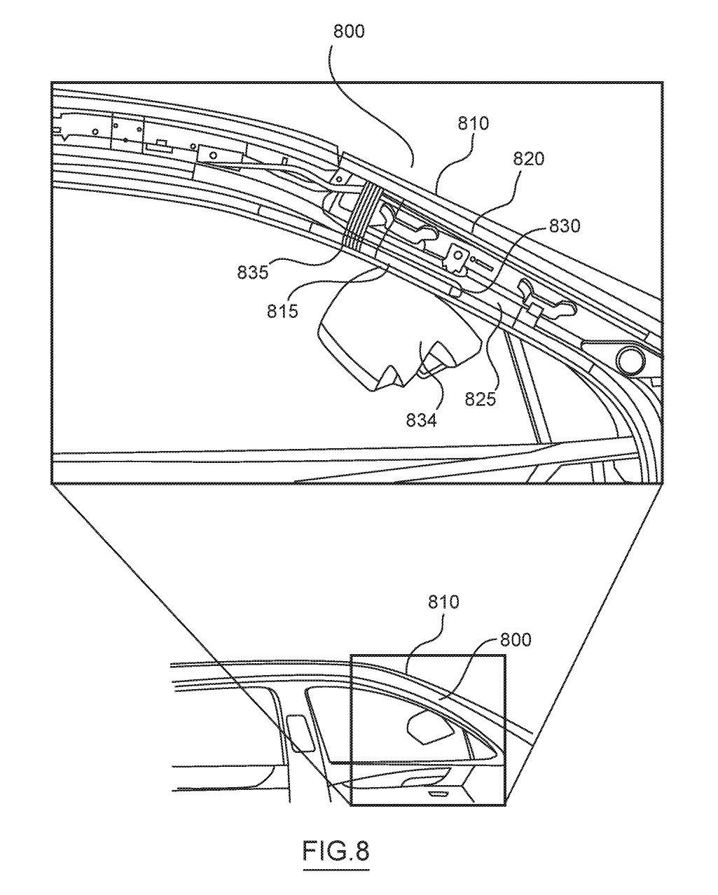

FIG. 8 illustrates the location in a vehicle 800 of the trim bumper element 820 supporting the RRAB 825 with serrated curved protrusions 830 of the trim bumper element 820. The trim bumper element 820 is attached to the pillar assembly 810 and holds the trim component assembly 835. At a point of contact 815 by a movable element 831 to the surface of the trim component assembly 835, the force of the impact is transferred to the trim bumper element 820 which the thickness varies along the cross section with grooves of the serrated curved protrusions 830.

The trim bumper element 820 flexes or bends through compression and decompression in response to the impact forces and depending on the force of the impact will deform from a base shape to absorb the impact forces. In addition, the RRAB 825 may be deployed from the hold position by the trim bumper element 820. The trim assembly component is held in place for a period as the impact forces are transferred and then may be released if the forces are beyond a threshold to allow for deployment of the RRAB 825. The contour surface of the trim bumper element 820 may be irregularly configured and well as extended to the distal end sections for attaching to the pillar assembly 810 for flexibility and to prevent impeding or obstructing visibility of the trim component assembly 835.

Accordingly, a trim bumper element system and a method provide tunable stiffness that may be tailored through variations in cross sectional thickness enabled by using plastic or rubber type materials. High fatigue life is achievable with lifetime consistent performance as a result of limited bending and deformation of the trim bumper element by virtue of its insertion between the trim component assembly and the metal sheath of the pillar assembly.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A system comprising:
a trim component assembly affixed to a pillar assembly, and
a trim bumper element inserted between the trim component assembly and the pillar assembly to support the trim component assembly during an impact, the trim bumper element configured to deflect from a base shape when a load is applied to the trim bumper element to prevent for a period a detaching of the trim component assembly from the pillar assembly by enabling a load of a constant force to be received by the trim component assembly by a transfer of force related to the load in part to the pillar assembly while the base shape of the trim bumper element deforms in response to the load applied.

2. The system of claim 1, further comprising:
One or more extensions extending from the trim bumper element configured to hold an airbag prior to deployment during the impact wherein the extension bend in response to the load applied to absorb the force of the load in part.

3. The system of claim 2 wherein the one or more extensions bend in manner not to impede the deployment of the airbag.

4. The system of claim 1 wherein the trim bumper element is configured to vary the force as the trim bumper element deflects the load.

5. The system of claim 1 wherein the trim bumper element has a shape that is irregular and that is determined by a cavity within which the trim bumper element is disposed.

6. The system of claim 1 wherein the trim bumper element has a side view with a width, wherein the width varies along the length of the trim bumper element.

7. The system of claim 3 wherein the extensions include ribs and grooves which are configured to vary the force of support of the airbag as the trim bumper element deflects the applied load.

8. The system of claim 1 wherein the trim bumper element has a figure eight shape on a distal end.

9. A method of energy absorption, comprising:
Forming a trim bumper element in a base shape which deflects when a load is applied to the trim bumper element, the trim bumper element formed of a polymer material; and
Positioning an impact element so that the trim bumper element is responsive to a force applied by the impact element to transfer the force to a pillar assembly of the vehicle.

10. The method of claim 9, further comprising:
Forming the trim bumper element with an extension that is configured to vary the force as the trim bumper element deflects the load.

11. The method of claim 9, further comprising:
Forming the trim bumper element with a shape that is irregular and that is determined by a space within which the elastic element is disposed.

12. The method of claim 9, further comprising:
Shaping the trim bumper element on a distal end with an extension to hold an airbag.

13. The method of claim 9, further comprising:
Shaping the trim bumper element with sections of different widths for affixing to pillar assembly.

14. The method of claim 10, further comprising:
Casting grooves in the extension wherein the grooves are configured to vary the force as the trim bumper element deflects the load.

15. The method of claim 9, further comprising:
Deforming the trim bumper element to absorb the force of the impact element.

16. The method of claim 15, the deforming further comprising:
Bending the trim bumper element in a manner not to interfere with a deployment of an airbag.

17. An apparatus for absorbing load forces comprising:
A trim component assembly affixed to a pillar assembly, and
a trim bumper element inserted between the trim component assembly and the pillar assembly to support the trim component assembly during an impact, the trim bumper element configured to deflect from a base shape when a load is applied to the trim bumper element to prevent for a period a detaching of the trim component assembly from the pillar assembly by enabling a load of a constant force to be received by the trim component assembly by a transfer of force related to the load in part to the pillar assembly while the base shape of the trim bumper element deforms in response to the load applied.

18. The apparatus of claim 17 further comprising:
One or more extensions extending from the trim bumper element configured to hold an airbag prior to deployment during the impact wherein the extension bend in response to the load applied to absorb the force of the load in part.

19. The apparatus of claim 18 wherein the one or more extensions bend in manner not to impede the deployment of the airbag.

20. The apparatus of claim 17 wherein the trim bumper element is configured to vary the force as the trim bumper element deflects the load.
